(19) United States
(12) Patent Application Publication
(10) Pub. No.: US 2011/0214754 A1
(43) Pub. Date: Sep. 8, 2011

(54) BALL VALVE TOILET BOWL VALVE FILL SYSTEMS

(76) Inventor: Kurt Allen, Hurricane, WV (US)

(21) Appl. No.: 12/857,449

(22) Filed: Aug. 16, 2010

Related U.S. Application Data
(60) Provisional application No. 61/311,564, filed on Mar. 8, 2010.

(51) Int. Cl. F16K 31/18

(52) U.S. Cl. 137/441

(57) ABSTRACT

A ball valve toilet bowl fill valve as a replacement for existing diaphragm-type shut-off valve assemblies for use with existing toilet systems is disclosed herein comprising: a valve body having a ball valve; a float and rod mechanism; a water inlet which allows water to enter to provide a water level in a toilet tank; a toilet fill; and a flange. The float and rod mechanism is buoyancy adjustable according to the water level present in the toilet tank such that the float and rod mechanism manipulates the ball valve within the valve body to control at least one water flow through the toilet fill. The ball valve toilet bowl fill valve is preferably sealably secured to the toilet tank via the flange in conjunction with a seal creating a substantially leak-free effective and efficient service for flush tank toilets. A kit and method of use/installation for the ball valve toilet bowl fill valve system is also disclosed suitable for replacing a diaphragm-type shut-off valve in a flush toilet.

### CROSS-REFERENCE TO RELATED APPLICATION

The present application is related to and claims priority from prior provisional application Ser. No. 61/311,564, filed Mar. 8, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of fill valves and more specifically relates to toilet fill valves.

2. Description of the Related Art

Toilets are plumbing fixtures primarily intended for the disposal of human excreta including urine and fecal matter. Toilets used in developed countries are typically flush toilets. Flush toilets dispose of the human waste by using water from a water source to flush the excreta through a drainpipe to another location. Tank fill valves are found in most tank-style toilets to regulate the water flow. The valves are typically of two main designs: the side-float design and the concentric-float design. The side-float design typically incorporates a float, usually ball-shaped, which is located to one side of the main valve tower at the end of a rod or arm. As the side-float rises, so does the side-float-arm. The arm is connected to a linkage which blocks the water flow into the toilet tank, and thus maintains a constant level in the tank. Concentric-float fill valves consist of a tower which is encircled by a plastic float assembly. Operation is otherwise the same as with a side-float fill valve, even though the float position is somewhat different. Interference between the float and other obstacles (tank insulation, flush valve, and so on) with the concentric-float fill valve(s) versions is greatly reduced, thus increasing reliability. The concentric-float fill valve is also designed to automatically signal to users when there is a leak in the tank, by making much more noise when a leak is present than the side-float fill valve. These valves are normally housed in toilet water tanks.

The water tanks found on most household toilets utilize a diaphragm-type fill valve. Problems exist with diaphragm-type fill valves because they are specific to gases and not liquids making them less effective and more susceptible to leakage. Diaphragm-type valves are also conventionally made of rubber, which can break down over time requiring the user to replace the part. A more effective fill valve is needed that is specific to water and reduces leakage.

Various attempts have been made to solve the above-mentioned problems such as those found in U.S. Pat. Nos. 3,086,217; 6,823,889; 5,054,131; 5,878,775; 1,403,688; and 5,042,095. This prior art is representative of toilet fill valves. None of the above inventions and patents, taken either singly or in combination, is seen to describe the invention as claimed.

Ideally, toilet fill valves should require minimal maintenance and, yet operate reliably and be manufactured at a modest expense. Thus, a need exists for reliable ball valve toilet bowl fill valve systems to provide substantially leak-free effective and efficient service for flush tank toilets and to avoid the above-mentioned problems.

### BRIEF SUMMARY OF THE INVENTION

In view of the foregoing disadvantages inherent in the known toilet fill valve art, the present invention provides a novel ball valve toilet bowl fill valve system. The general purpose of the present invention, which will be described subsequently in greater detail is to provide substantially leak-free effective and efficient service for flush tank toilets.

A ball valve toilet bowl fill valve as a replacement for existing diaphragm-type shut-off valve assemblies for use with existing toilet systems is disclosed herein comprising: a valve body having a ball valve; a float and rod mechanism; a water inlet which allows water to enter to provide a water level in a toilet tank; a toilet fill; and a flange. The float and rod mechanism is buoyancy adjustable according to the water level present in the toilet tank such that the float and rod mechanism manipulates the ball valve within the valve body to control at least one water flow through the toilet fill. The ball valve toilet bowl fill valve is preferably sealably secured to the toilet tank via the flange in conjunction with a seal. In certain embodiments the float and rod mechanism comprises a float removably attached to a rod. The float and rod mechanism is attached to the ball valve and is rotatable about a centerline axis of the ball valve. In this way the ball valve is manipulated between at least one open position and at least one closed position via the float and rod mechanism accordingly to the water level in the toilet tank.

The open position of the ball valve toilet bowl fill valve comprises a condition wherein the float of the float and rod mechanism is in a position adjacent the bottom of the toilet tank. The open position permits the water flow to occur through the ball valve, to the toilet fill thereby allowing the toilet tank to fill with water. The closed position comprises a condition wherein the float of the float and rod mechanism is in a position adjacent the top of the toilet tank. The closed position comprises a condition wherein the float of the float and rod mechanism is in a position substantially perpendicular to the water inlet, a condition wherein the water level is at a position higher than in the open position in the toilet tank thereby preventing the water flow to occur.

In certain embodiments the valve body may comprise molded stops on the valve body for the open or closed ball settings. The valve body may also comprise a bowl fill outlet nipple at the top of the valve to allow the bowl fill water to flow when the ball valve is open. In other embodiments the ball valve may be molded onto the rod creating the float and rod mechanism and/or float and rod mechanism assembly.

Next, a kit for the ball valve toilet bowl fill valve system is disclosed suitable for replacing a diaphragm-type shut-off valve in a flush toilet comprising: at least one valve body assembly having a ball valve and a toilet fill; a float and rod mechanism; a water inlet and flange assembly; and a set of user instructions.

Additionally, a method for replacing a diaphragm-type shut-off valve assembly in a flush toilet tank with a ball valve toilet bowl fill valve assembly is described comprising the steps of: shutting off a valve to a water source to the flush toilet tank (to stop water flow and toilet tank may optionally be drained); next removing the diaphragm-type shut-off valve assembly; replacing the diaphragm-type shut-off valve assembly with the ball valve toilet bowl fill valve assembly; sealing the ball valve toilet bowl fill valve assembly to the flush toilet tank; and opening the valve to the water source to said flush toilet tank.

The present invention holds significant improvements and serves as a ball valve toilet bowl fill valve system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ball valve toilet bowl fill valve systems, constructed and operative according to the teachings of the present invention.

FIG. 1 shows a perspective view illustrating a ball valve toilet bowl fill valve for use in a toilet tank according to an embodiment of the present invention.

FIG. 2 is a perspective view illustrating the ball valve toilet bowl fill valve in an open position according to an embodiment of the present invention of FIG. 1.

FIG. 3 is a perspective view illustrating the ball valve toilet bowl fill valve in a closed position according to an embodiment of the present invention of FIG. 1.

FIG. 4 is a perspective view illustrating the ball valve toilet bowl fill valve in the closed position according to an embodiment of the present invention of FIGS. 1 and 3.

FIG. 5 is a perspective view illustrating the ball valve toilet bowl fill valve in the open position according to an embodiment of the present invention of FIGS. 1 and 2.

FIG. 6 is a flowchart illustrating a method for installation of the ball valve toilet bowl fill valve according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a fill valve device and more particularly to a toilet fill valve device as used to improve the efficiency and effectiveness of flush toilet systems. Water tanks found on most household toilets utilize a diaphragm-type fill valve. As mentioned, these valves are specific to gases and not liquids making them less effective and more susceptible to leakage. Diaphragm-type valves are also conventionally made of rubber, which may break down over time requiring the user to replace the part. The present invention serves to solve these problems in a cost-effective manner as disclosed below as an improved alternative for fill valves presently used in flush toilet tanks. Generally, plumbers, homeowners and building managers will benefit from replacing their standard toilet bowl fill valves with the disclosed novel device.

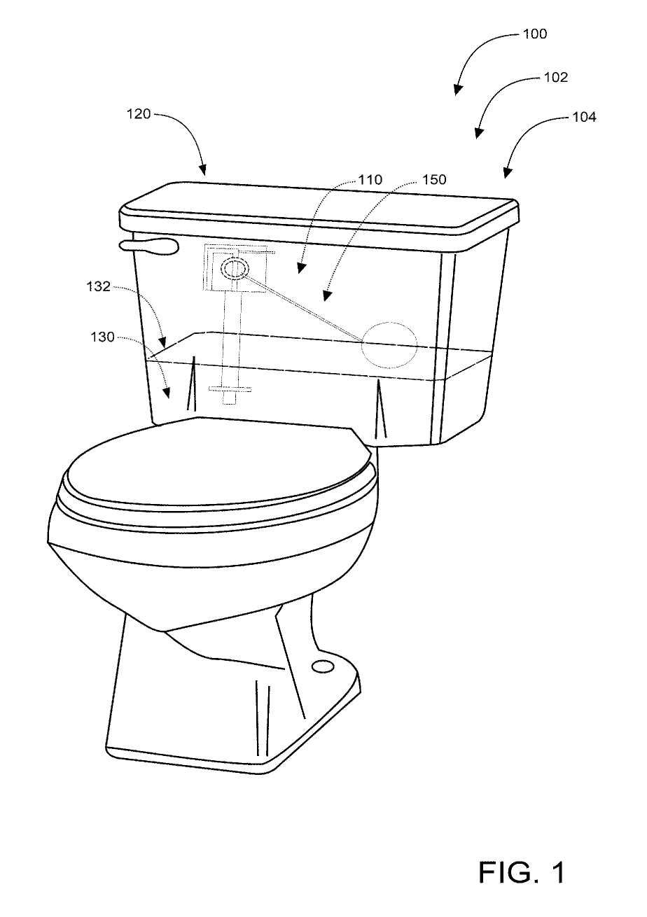

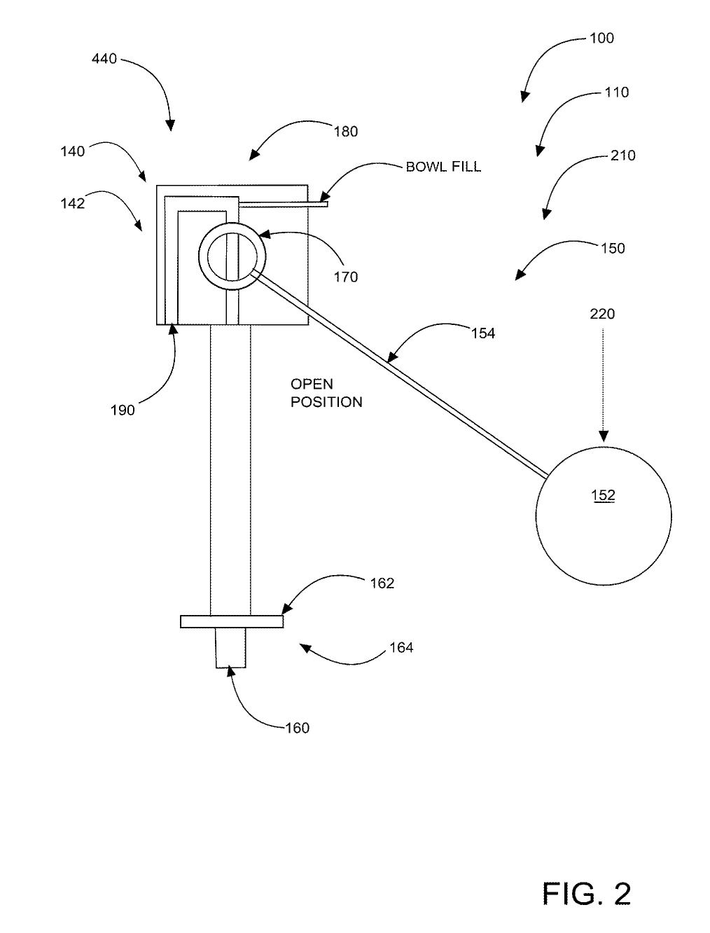

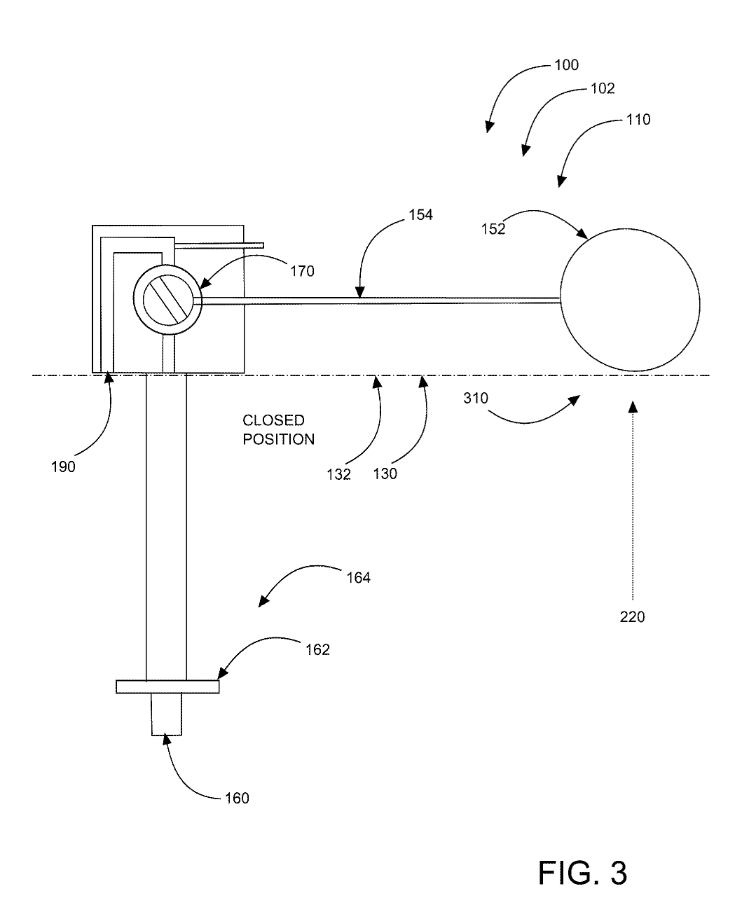

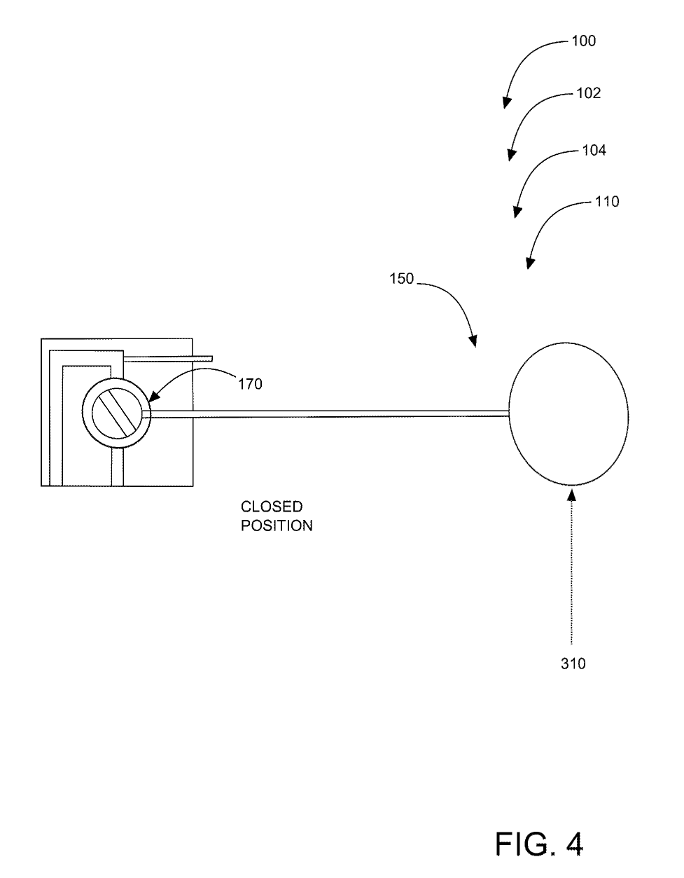

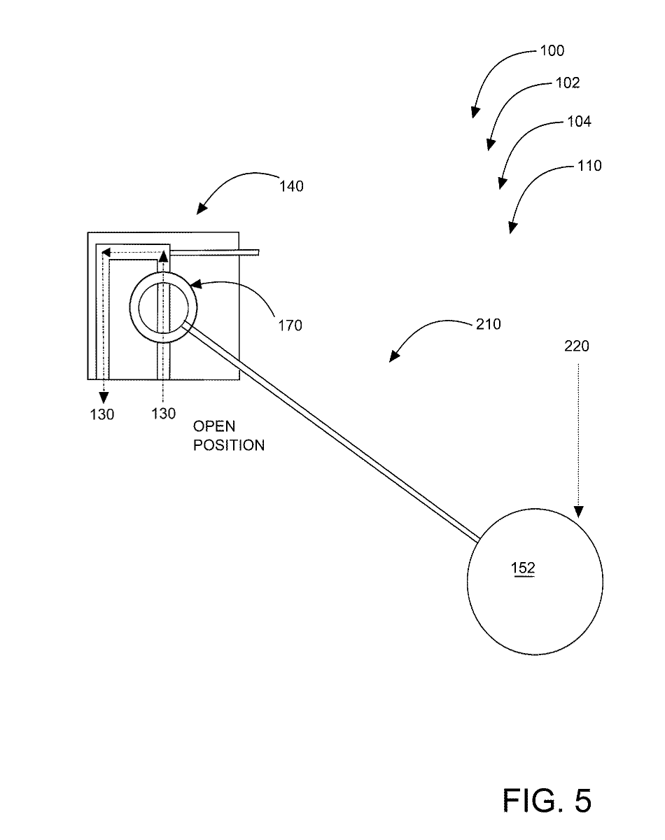

Now, referring to the drawings by numerals of reference there is shown in FIG. 1, ball valve toilet bowl fill valve 110 for use in toilet tank 120 according to an embodiment of the present invention. Ball valve toilet bowl fill valve 110 within the present invention comprises valve system 100 for toilet tanks 120 that serves as a replacement for a diaphragm-type shut-off valves with ball valve 170 (ball valve toilet bowl fill valve 110). Ball valve toilet bowl fill valve 110 of valve system 100 is preferably controlled by float and rod mechanism 150 designed to substantially eliminate leakage. As water 130 enters valve body 140 through an inlet supply, (water inlet 160) it passes through ball valve 170, which then preferably rotates to at least one open position 210 (as shown in FIGS. 2 and 5) or to at least one closed position 310 (as shown in FIGS. 3 and 4) via float and rod mechanism 150. When float and rod mechanism 150 allows ball valve 170 to be open, water 130 passes through to top valve 180 where it is free to then flow into toilet tank 120 through an outer chamber in valve body 140.

Ball valve 170 is preferably manipulated between at least one open position 210 and at least one closed position 310 via float and rod mechanism 150 accordingly to water level 132 in toilet tank 120 to provide and regulate sufficient stored flushing means in a cost-efficient and environmentally-friendly manner.

Referring now to FIGS. 2, and 5 showing ball valve toilet bowl fill valve 110 in open position 210 according to an embodiment of the present invention of FIG. 1.

Valve system 100 as discussed herein comprises Ball valve toilet bowl fill valve 110 within the present invention preferably comprises: valve body 140 having ball valve 170; float and rod mechanism 150; water inlet 160 which allows water 130 to enter (from source) to provide and regulate water level 132 in toilet tank 120. Valve system 100 further comprises toilet fill 190; and flange 162. Flange 162 may be sealingly engaged to toilet tank 120 via a seal (not shown) to prevent leakage.

Float and rod mechanism 150 is buoyancy-adjustable according to water level 132 present in toilet tank 120 such that float and rod mechanism 150 manipulates ball valve 170 within valve body 140 to control at least one water flow through toilet fill 190. Float and rod mechanism 150 rests on top of water 130 above water level 132 as it rises and falls due to the effects of buoyancy, the upward pressure/force of water 130 acting on float 152. Ball valve toilet bowl fill valve 110 is secured to toilet tank 120 via flange 162.

Float and rod mechanism 150 comprises float 152 removably attached to at least one rod 154 and in certain embodiments float 152 and rod 154 may be molded as a one-piece-construction or alternately be threadingly engaged to form an assembly. Float and rod mechanism 150 is attached to ball valve 170 and is rotatable about a centerline axis of ball valve 170. Float and rod mechanism 150 and ball valve 170 cooperate to provide regulation means such that a suitable water level 132 is maintained, before, during and after the flushing has occurred. Further, use of ball valve 170 promotes efficiency because of its inherent durable construction and reduces maintenance and damage caused by leaks. The present invention is also cost-effective because most of the components can be purchased as off-the-shelf items.

FIGS. 2 and 5 show open position 210 as demonstrated by direction-indication arrow 220 wherein float and rod mechanism 150 comprises a position lower relative to bottom of toilet tank 120 than that of closed position 310. Open position 210 comprises a condition wherein float 152 of float and rod mechanism 150 is in a position adjacent the bottom of toilet tank 120. Open position 210 permits at least one water flow to occur through to toilet fill 190 thereby allowing toilet tank 120 to fill with water 130 to maintain water level 132.

Referring now to FIGS. 3 and 4, showing ball valve toilet bowl fill valve 110 in closed position 310 according to an embodiment of the present invention of FIG. 1.

Closed position 310 comprises a condition wherein float of float and rod mechanism 150 is in a position adjacent the top of toilet tank 120. Closed position 310 comprises a condition wherein float 152 of float and rod mechanism 150 is in a position perpendicular to water inlet 160. Closed position 310 comprises a condition wherein water level 132 is at a position higher than open position 210 in toilet tank 120 thereby preventing water flow from occurring. Closed position 310 to open position 210 comprises a rotation angle of less than 90 degrees.

The majority of components in the present invention may be comprised of plastic, including but not limited to ABS and nylon and be available in two main (standard) sizes. Dimensions for the smaller version can measure approximately 8⅕″H×8½″L×1½″W×1½″D and the larger design can measure 12″H×12″L×1½″W×1½″D. Ball valve toilet bowl fill valve assembly 102 is designed such that water 130 can enter into valve body 140 through an inlet supply from a pressurized water source and pass through ball valve 170. Ball valve 170 can be rotated to open position 210 or to closed position 310 by float and rod mechanism 150 to allow ingress or impede (block) ingress of water 130. When float 152 allows ball valve 170 to be open, water 130 passes through to the top of ball valve 170 where water 130 can then flow into toilet tank 120 through the chamber of valve body 140. There may be molded stops on valve body 140 for the open or closed ball settings. Upon reading this specification, it should be appreciated that, under appropriate circumstances, considering such issues as user preferences, design preference, structural requirements, marketing preferences, cost, available materials, technological advances, etc., other dimensions and arrangements such as, for example, versions for larger or smaller toilets, for toilets comprising differing and non-flushing means, etc., may be sufficient.

Valve body 140 of ball valve toilet bowl fill valve 110 comprises a bowl fill outlet nipple. There can also be a bowl fill outlet nipple at the top of the valve to allow the bowl fill water to flow when the ball valve 170 is open. Further, ball valve 170 can be molded onto rod 154. Rod 154 and inlet seal do not comprise plastic within the preferred embodiment of the present invention and comprise other appropriate materials. Upon reading this specification, it should be appreciated that, under appropriate circumstances, considering such issues as user preferences, design preference, structural requirements, marketing preferences, cost, available materials, technological advances, etc., other materials and arrangements such as, for example, seal(s), rod and other components may be made from various corrosion resistant materials, etc., may be sufficient.

A kit 440 for a ball valve toilet bowl fill valve system 104 for replacing a diaphragm-type shut-off valve in a flush toilet may comprise: at least one valve body assembly 142 having ball valve 170 and toilet fill 190; a float and rod mechanism 150; water inlet and flange assembly 164; and a set of user instructions (not shown). Kit 440 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

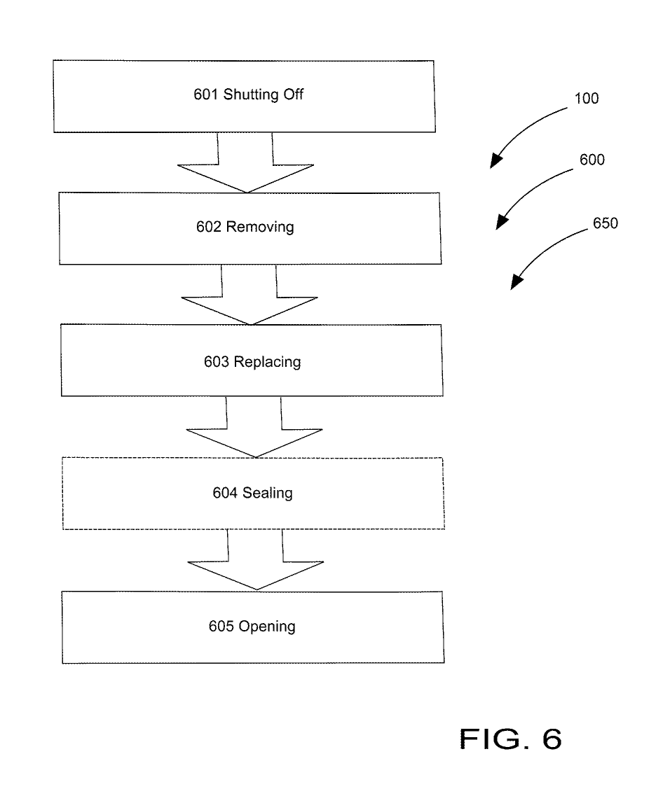

Referring now to FIG. 6 showing a flowchart 650 illustrating a method 600 for installation of ball valve toilet bowl fill valve 110 according to an embodiment of the present invention of FIGS. 1-5.

Method 600 for replacing a diaphragm-type shut-off valve assembly in a flush toilet tank 120 with a ball valve toilet bowl fill valve assembly 102 comprising the steps of: step one 601 shutting off a valve to water source to flush toilet tank 120; step two 602 removing the diaphragm-type shut-off valve assembly; step three 603 replacing the diaphragm-type shut-off valve assembly with ball valve toilet bowl fill valve assembly 102; step four 604 sealing ball valve toilet bowl fill valve assembly 102 to flush toilet tank 120; and step five 605 opening the valve to the water source to flush toilet tank 120. Optional steps of method 600 are illustrated using dotted lines in FIG. 6 so as to distinguish them from the other steps of method 600.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ball valve toilet bowl fill valve comprising:
a valve body having a ball valve;
a float and rod mechanism;
a water inlet which allows water to enter to provide a water level in a toilet tank;
a toilet fill;
a flange;
wherein said float and rod mechanism is buoyancy adjustable according to said water level present in said toilet tank such that said float and rod mechanism manipulates said ball valve within said valve body to control at least one water flow through said toilet fill; and
wherein said ball valve toilet bowl fill valve is secured to said toilet tank via said flange.

2. The ball valve toilet bowl fill valve of claim 1 wherein said float and rod mechanism comprises a float removably attached to a rod wherein said float and rod mechanism is attached to said ball valve and is rotatable about a centerline axis of said ball valve.

3. The ball valve toilet bowl fill valve of claim 2 wherein said ball valve is manipulated between at least one open position and at least one closed position via said float and rod mechanism accordingly to said water level in said toilet tank.

4. The ball valve toilet bowl fill valve of claim 3 wherein said at least one open position comprises a condition wherein said float of said float and rod mechanism is in a position adjacent bottom of said toilet tank.

5. The ball valve toilet bowl fill valve of claim 3 wherein said at least one closed position comprises a condition wherein said float of said float and rod mechanism is in a position adjacent top of said toilet tank.

6. The ball valve toilet bowl fill valve of claim 4 wherein said at least one open position permits said water flow to occur to said toilet fill thereby allowing said toilet tank to fill with water.

7. The ball valve toilet bowl fill valve of claim 5 wherein said at least one closed position comprises a condition wherein said float of said float and rod mechanism is in a position perpendicular to said water inlet.

8. The ball valve toilet bowl fill valve of claim 7 wherein said at least one closed position comprises a condition wherein said water level is at a position higher than said open position in said toilet tank thereby preventing said water flow to occur.

9. The ball valve toilet bowl fill valve of claim 1 wherein said valve body comprises molded stops.

10. The ball valve toilet bowl fill valve of claim 1 wherein said valve body comprises a bowl fill outlet nipple.

11. The ball valve toilet bowl fill valve of claim 2 wherein said ball valve is molded onto said rod.

12. A kit for a ball valve toilet bowl fill valve system for replacing a diaphragm-type shut-off valve in a flush toilet comprising:
at least one valve body assembly having a ball valve and a toilet fill;
a float and rod mechanism;
a water inlet and flange assembly; and
a set of user instructions.

13. A method for replacing a diaphragm-type shut-off valve assembly in a flush toilet tank with a ball valve toilet bowl fill valve assembly comprising the steps of:
shutting off a valve to water source to said flush toilet tank;
removing said diaphragm-type shut-off valve assembly;
replacing said diaphragm-type shut-off valve assembly with said ball valve toilet bowl fill valve assembly;
sealing said ball valve toilet bowl fill valve assembly to said flush toilet tank; and
opening said valve to said water source to said flush toilet tank.
